(19) United States
(12) Patent Application Publication
(10) Pub. No.: US 2025/0364556 A1
(43) Pub. Date: Nov. 27, 2025

(54) FACILE SYNTHESIS OF HIERARCHICAL PARTICLES OF SODIUM VANADIUM PHOSPHATE FOR SODIUM-BASED BATTERIES

(71) Applicant: Washington University, St. Louis, MO (US)

(72) Inventors: Peng BAI, St. Louis, MO (US); Ethan Boutelle, St. Louis, MO (US)

(21) Appl. No.: 19/217,906

(22) Filed: May 23, 2025

Related U.S. Application Data
(60) Provisional application No. 63/650,976, filed on May 23, 2024.

(51) Int. Cl. H01M 4/58; C01B 25/45; H01M 4/02; H01M 4/36; H01M 10/054

(52) U.S. Cl. CPC H01M 4/5825; C01B 25/45; H01M 4/366; C01P 2002/72; C01P 2002/82; C01P 2002/88; C01P 2004/03; C01P 2004/32; C01P 2004/80; C01P 2006/12; C01P 2006/16; C01P 2006/40; H01M 2004/021; H01M 10/054

(57) ABSTRACT

Described herein are carbon-coated sodium vanadium phosphate (NVP-C) microspheres, methods of synthesizing same, and batteries including same.

### CROSS-REFERENCE TO RELATED APPLICATIONS

This application claims priority to U.S. Provisional Application No. 63/650,976, filed on May 23, 2022, the contents of which are incorporated by reference herein.

### GOVERNMENT SUPPORT CLAUSE

This invention was made with government support under CBET2044932 awarded by the National Science Foundation. The government has certain rights in the invention.

### FIELD OF THE DISCLOSURE

Described herein are carbon-coated sodium vanadium phosphate (NVP-C) microspheres, methods of synthesizing same, and batteries including same.

### BACKGROUND

Worldwide electricity demand, mostly satisfied through coal and natural gas combustion, is expected to double by the middle of the century. As climate change presents more urgent challenges, renewable energy sources are becoming increasingly necessary. However, their inherent variability requires reliable, high-density energy storage. Due to their energy density and longevity, lithium-ion batteries (LIBs) currently lead in meeting this demand, but the increasing depletion of sources of lithium and associated cathode materials, such as cobalt and nickel, has led to higher cost and greater environmental and ethical production concerns. Sodium-ion batteries (NIBs) are a promising alternative because the abundance of sodium and associated cathode materials results in lower cost and less environmental impact. NIBs particularly excel in grid-scale energy storage, because stationary storage prioritizes larger and cheaper batteries over the high energy density provided by lithium-ion batteries. At present, NIBs are limited by the performance of their cathodes, but once a successful cathode material is developed, NIB production can start quickly due to similarities with existing LIB production methods.

Sodium-ion battery cathodes have been studied extensively. Layered metal oxides can provide capacities as high as 228 mAh g⁻¹ with high redox potentials, but they suffer from poor capacity retention due to Jahn-Teller distortion and irreversible phase transition. Prussian blue analogues (PBAs) can reach specific capacities of 152.8 mAh g⁻¹ but suffer similar capacity fading due to Jahn-Teller distortion and residual interstitial water. Furthermore, PBAs are rate-limited by electronic conduction and depend on sensitive synthesis parameters, such as pH.

As a more promising and durable NIB cathode material, Na₃V₂(PO₄)₃ (NVP) has a sodium superionic conductor (NASICON) structure that provides rapid Na⁺ ion conductivity while maintaining a stable intercalation framework. It also offers a high theoretical capacity of 117 mAh g⁻¹ and high thermal stability. However, NVP has unfavorably low electronic conductivity (1.63×10⁻⁶ S cm⁻¹). This limitation can be alleviated by carbon coating, through in-situ or post-synthesis techniques, while maintaining a porous and stable material. Another major obstacle to NVP production is that common synthesis routes, (e.g., sol-gel, hydrothermal, freeze-drying, and electrospinning methods) are expensive and energy intensive. Therefore, creating a more sustainable synthesis method, while maintaining high performance and material stability, will lead to cheap and reliable NIBs suited for large-scale applications.

Accordingly, there is a need for improved methods of synthesizing carbon-coated NVP (NVP-C).

### BRIEF DESCRIPTION OF THE DISCLOSURE

In one aspect, the present disclosure is directed to a method to synthesize carbon-coated sodium vanadium phosphate (NVP-C) microspheres. The method includes: ball milling a mixture of a sodium phosphate source, a vanadium source, a carbon source, and a solvent to form a precursor; spray drying the precursor; and calcinating the precursor.

In another aspect, the present disclosure is directed to carbon-coated sodium vanadium phosphate (NVP-C) microspheres, which are produced according to a method including: ball milling a mixture of a sodium phosphate source, a vanadium source, a carbon source, and a solvent to form a precursor; spray drying the precursor, and calcinating the precursor.

In another aspect, the present disclosure is directed to carbon-coated sodium vanadium phosphate (NVP-C) microspheres comprising at least one of the following properties: (i) a surface area in a range of from about 20 m² g-1to about 100 m² g⁻¹; (ii) a morphology selected from the group consisting of hierarchical spherical secondary particles composed of nano-sized primary particles, hierarchical plate-like secondary particles composed of nano-sized primary particles, and combinations thereof; (iii) a pore size distribution selected from the group consisting of a pore size distribution closely centered around 5 nm in diameter, widely distributed between 5 nm to 40 nm in diameter, and combinations thereof; and (iv) a carbon coating thickness in a range of from about 5 nm to about 30 nm.

### BRIEF DESCRIPTION OF THE DRAWINGS

FIG. 1 depicts a schematic of the one-pot NVP-C synthesis in accordance with the present disclosure.

FIG. 2A depicts SEM images of the final NVP-C calcified product for NVP-150R in accordance with the present disclosure.

FIG. 2B depicts SEM images of the final NVP-C calcified product for NVP-150 in accordance with the present disclosure.

FIG. 2C depicts SEM images of the final NVP-C calcified product for NVP-210 in accordance with the present disclosure.

FIG. 2D depicts nitrogen adsorption-desorption isotherms of the three NVP-C materials in accordance with the present disclosure.

FIG. 2E depicts surface area pore size distributions of the three NVP-C materials in accordance with the present disclosure.

FIG. 3A depicts TGA curves under an air atmosphere, providing approximate carbon contents, for the NVP-C samples in accordance with the present disclosure.

FIG. 3B depicts Raman spectroscopy, with D and G bands labeled, for the NVP-C samples in accordance with the present disclosure.

FIG. 3C depicts XRD patterns and Bragg positions from PDF card #00-062-0345 (ICDD) for the NVP-C samples in accordance with the present disclosure.

FIG. 4A depicts cyclic voltammetry curves at 0.1 mv s⁻¹, 0.6 mv s⁻¹, and 1 mv s⁻¹, with the inset showing the relationship of iₚ and v^{1/2}, of the prepared NVP-C materials as cathodes and mixed with 10 wt. % Ketjenblack EC-300J in Na-ion half-cells in accordance with the present disclosure.

FIG. 4B depicts discharge specific capacity of the prepared NVP-C materials as cathodes and mixed with 10 wt. % Ketjenblack EC-300J in Na-ion half-cells in accordance with the present disclosure.

FIG. 4C depicts galvanostatic discharge profiles of the prepared NVP-C_210° C. as cathode and mixed with 10 wt. % Ketjenblack EC-300J in Na-ion half-cells during ramp tests at C rates of 0.2 C, 0.5 C, 1 C, 2 C, 5 C, 10 C, 20 C, and 30 C in accordance with the present disclosure.

FIG. 4D depicts cyclic voltammetry curves at 0.1 mv s⁻¹, 0.6 mv s⁻¹, and 1 mv s⁻¹, with the inset showing the relationship of iₚ and v^{1/2}, of the prepared NVP-C materials as cathodes and mixed with 10 wt. % Ketjenblack EC-600J in Na-ion half-cells in accordance with the present disclosure.

FIG. 4E depicts discharge specific capacity of the prepared NVP-C materials as cathodes and mixed with 10 wt. % Ketjenblack EC-600J in Na-ion half-cells in accordance with the present disclosure.

FIG. 4F depicts galvanostatic discharge profiles of the prepared NVP-C_210° C. as cathode and mixed with 10 wt. % Ketjenblack EC-600J in Na-ion half-cells during ramp tests at C rates of 0.2 C, 0.5 C, 1 C, 2 C, 5 C, 10 C, 20 C, and 30 C in accordance with the present disclosure.

FIG. 5A depicts long-term cycling and discharge capacities and coulombic efficiencies of the three NVP-C materials at 10 C mixed with Ketjenblack EC-300J in accordance with the present disclosure.

FIG. 5B depicts galvanostatic potential profiles of the 1^{st}, 1000^{th}, and 2000^{th} cycles of the three NVP-C materials at 10 C mixed with Ketjenblack EC-300J in accordance with the present disclosure.

FIG. 5C depicts long-term cycling and discharge capacities and coulombic efficiencies of the three NVP-C materials at 10C mixed with Ketjenblack EC-600J in accordance with the present disclosure.

FIG. 5D depicts galvanostatic potential profiles of the 1^{st}, 1000^{th}, and 2000^{th} cycles of the three NVP-C materials at 10 C mixed with Ketjenblack EC-600J in accordance with the present disclosure.

FIG. 6A depicts discharge capacity and coulombic efficiency of low-capacity (thin loading at about 1 mg/cm²) NVP-210 cathodes mixed with Ketjenblack EC-600J cycled at 10 C in accordance with the present disclosure.

FIG. 6B depicts galvanostatic potential profiles of low-capacity (thin loading at about 1 mg/cm²) NVP-210 cathodes mixed with Ketjenblack EC-600J cycled at 10 C in accordance with the present disclosure.

FIG. 6C depicts discharge capacity and coulombic efficiency of high-capacity (thick loading at about 13.5 mg/cm²) NVP-210 cathodes mixed with Ketjenblack EC-600J cycled at 0.5 C in accordance with the present disclosure.

FIG. 6D depicts galvanostatic potential profiles of high-capacity (thick loading at about 13.5 mg/cm²) NVP-210 cathodes mixed with Ketjenblack EC-600J cycled at 0.5° C. in accordance with the present disclosure.

FIG. 7A depicts SEM images of NVP-L samples in accordance with the present disclosure.

FIG. 7B depicts SEM images of NVP-Lr samples in accordance with the present disclosure.

FIG. 7C depicts SEM images of NVP-S samples in accordance with the present disclosure.

FIG. 7D depicts SEM images of NVP-Sr samples in accordance with the present disclosure.

FIG. 7E depicts BET characterization of samples in accordance with the present disclosure.

FIG. 8A depicts product cycling of NVP-L samples in accordance with the present disclosure.

FIG. 8B depicts product cycling of NVP-Lr samples in accordance with the present disclosure.

FIG. 8C depicts product cycling of NVP-S samples in accordance with the present disclosure.

FIG. 8D depicts product cycling of NVP-Sr samples in accordance with the present disclosure.

FIG. 9A depicts rate capability of NVP-L samples in accordance with the present disclosure.

FIG. 9B depicts rate capability of NVP-Lr samples in accordance with the present disclosure.

FIG. 9C depicts rate capability of NVP-S samples in accordance with the present disclosure.

FIG. 9D depicts rate capability of NVP-Sr samples in accordance with the present disclosure.

FIG. 10 depicts characterizations for a mixed carbon source sample in accordance with the present disclosure.

### DETAILED DESCRIPTION OF THE DISCLOSURE

Herein, a one-pot aqueous spray-drying process has been developed to replace traditional methods of synthesizing carbon-coated NVP (NVP-C). The process is easily scaled for industrial applications, and the synthesized samples demonstrate high rate performance, near-theoretical capacity, and a long working lifespan. This disclosure shows the very high potential for NVP-C as a cathode material for sustainable, reliable, and cost-efficient batteries.

Disclosed herein is a method to synthesize carbon-coated sodium vanadium phosphate (NVP-C) microspheres. The method includes: ball milling a mixture of a sodium phosphate source, a vanadium source, a carbon source, and a solvent to form a precursor; spray drying the precursor; and calcinating the precursor.

Generally, the sodium phosphate source may include any sodium phosphate source known in the art suitable to facilitate the method. In some embodiments, the sodium phosphate source is selected from the group consisting of sodium dihydrogen phosphate, disodium hydrogen phosphate, trisodium phosphate, monoammonium phosphate, and combinations thereof.

Generally, the vanadium source may include any vanadium source known in the art suitable to facilitate the method. In some embodiments, the vanadium source is selected from the group consisting of vanadium oxides, V₂O₅, V₂O₃, V₂O₄, VO₂, NH₄VO₃, and combinations thereof.

In some embodiments, the carbon source functions as a reducing agent for the vanadium source. In these embodiments, the carbon source facilitates reduction of the vanadium source and formation of the carbon-coated sodium vanadium phosphate (NVP-C) microspheres.

Generally, the carbon source may include any carbon source known in the art suitable to facilitate the method. In some embodiments, the carbon source is selected from the group consisting of citric acid, glucose, L-ascorbic acid, maltodextrin, oxalic acid, trehalose, sucrose, and combinations thereof.

Generally, the solvent may include any solvent known in the art suitable to facilitate the method. In some embodiments, the solvent is selected from the group consisting of water, methanol, and combinations thereof.

In some embodiments, the method is a one-pot method. In these embodiments, the precursor slurry is synthesized in a single reactor without transfer to another reactor.

In some embodiments, the spray drying the precursor occurs immediately after the ball milling. In some embodiments, immediately after the ball milling means within 10 seconds after ball milling. In some embodiments, immediately after the ball milling means within 60 seconds after ball milling. In some embodiments, immediately after the ball milling means within 300 seconds after ball milling. In some embodiments, immediately after the ball milling means within 600 seconds after ball milling. In some embodiments, immediately after the ball milling means within 1800 seconds after ball milling.

In some embodiments, the method further comprises resting the precursor after the ball milling. In these embodiments, resting the precursor means not moving, reacting, or disturbing the precursor.

In some embodiments, the resting occurs for a time of at least 15 minutes. In some embodiments, the resting occurs for a time of at least about one hour. In some embodiments, the resting occurs for a time of at least about four hours. In some embodiments, the resting occurs for a time of at least about eight hours. In some embodiments, the resting occurs for a time of at least about twelve hours. In some embodiments, the resting occurs for a time of at least about sixteen hours. In some embodiments, the resting occurs for a time of at least about twenty hours.

In some embodiments, the spray drying the precursor occurs after the resting the precursor.

Generally, calcining the precursor may include any calcining conditions known in the art suitable to facilitate the method. In some embodiments, calcination comprises applying an inert flowing gas (e.g., argon or nitrogen) at a flow rate higher than 100 mL per minute.

Generally, calcining the precursor does not require a pre-calcination heating step. Generally, calcining the precursor does not require a pre-calcination grinding step.

In some embodiments, calcining the precursor comprises a temperature in a range of from about 600° C. to about 1000°° C., or from about 700° C. to about 900° C. In some embodiments, calcining the precursor comprises calcining the precursor for a time in a range of from about 1 hour to about 16 hours, from about 4 to about 8 hours, or, from about 5 to about 6 hours. In some embodiments, calcining the precursor comprises applying a temperature in a range of from about 600° C. to about 1000° C. for a time in a range of from about 1 hour to about 16 hours.

A high-energy ball milling process is necessary to prepare the precursor suspension to down-size the insoluble solid particles and improve the mixing of all ingredients. In some embodiments, the size of the milling beads ranges from 0.1 mm to 10 mm, from about 1 mm to about 8 mm, or, from about 3 mm to about 5 mm. Ball milling with fine beads may also be referred to as sand milling.

In some embodiments, the precursor formulation does not require an inert-gas spray dryer.

Also disclosed herein are carbon-coated sodium vanadium phosphate (NVP-C) microspheres, which are produced according to a method including: ball milling a mixture of a sodium phosphate source, a vanadium source, a carbon source, and a solvent to form a precursor; spray drying the precursor, and calcinating the precursor.

The method disclosed herein does not require toxic and expensive organic solvents, does not require inert-gas spray dryers, and does not require expensive carbon additives (e.g., graphene or carbon nanotubes).

It has been discovered that the NVP-C microspheres produced according to the disclosed method possess unique properties compared to NVP-C microspheres produced according to other methods.

Also disclosed herein are carbon-coated sodium vanadium phosphate (NVP-C) microspheres comprising at least one of the following properties: (i) a surface area in a range of from about 20 m² g⁻¹ to about 100 m² g^{-1 ;} (ii) a morphology selected from the group consisting of hierarchical spherical secondary particles composed of nano-sized primary particles, hierarchical plate-like secondary particles composed of nano-sized primary particles, and combinations thereof; (iii) a pore size distribution selected from the group consisting of a pore size distribution closely centered around 5 nm in diameter, widely distributed between 5 nm to 40 nm in diameter, and combinations thereof; and (iv) a carbon coating thickness in a range of from about 5 nm to about 30 nm.

In some embodiments, the NVP-C microspheres comprise at least two of the foregoing properties. In some embodiments, the NVP-C microspheres comprise at least three of the foregoing properties. In some embodiments, the NVP-C microspheres comprise all four of the foregoing properties.

In some embodiments, the NVP-C microspheres comprise a surface area in a range of from about 20 m² g⁻¹ to about 100 m² g⁻¹, from about 40 m² g⁻¹ to about 80 m² g⁻¹, or, from about 50 m² g⁻¹ to about 70 m² g⁻¹.

In some embodiments, the NVP-C microspheres comprise a morphology selected from the group consisting of hierarchical spherical secondary particles composed of nano-sized primary particles, hierarchical plate-like secondary particles composed of nano-sized primary particles, and combinations thereof.

In some embodiments, the NVP-C microspheres comprise a pore size distribution selected from the group consisting of a pore size distribution closely centered around 5 nm in diameter, widely distributed between 5 nm to 40 nm in diameter, and combinations thereof.

In some embodiments, the NVP-C microspheres comprise a carbon coating thickness in a range of from about 5 nm to about 30 nm, from about 10 nm to about 20 nm, or from about 12 nm to about 16 nm.

In some embodiments, a cathode comprises the NVP-C microspheres. In some embodiments, a battery comprises the cathode. In some embodiments, the battery is a sodium-based battery. In some embodiments, the battery comprises a sodium metal anode. In some embodiments, the sodium for the sodium metal anode is derived completely from the synthesized NVP-C microspheres.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1. Exemplary Procedure and Results

### Synthesis

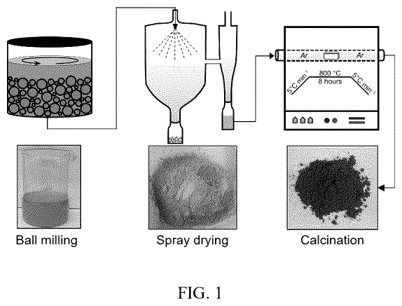

NVP-C microspheres were synthesized though ball milling, spray-drying, and subsequent calcination. As shown in FIG. 1, 22.46 g of NaH₂PO₄, 8.72 g of V₂O₅, and 4.67 g of C₆H₈O₆ were added to 200 mL of de-ionized water, and then ball milled with zirconium balls for 4 hours, alternating 5 minutes of milling with 5 minutes of rest. The resulting opaque turquoise suspension was further diluted with 100 mL of water to reduce clogging during spraying. The constantly mixed suspension was spray dried at either 150° C., to reduce the energy consumption of the process, or 210° C., for comparison with previous reports. The collected powder was calcinated at 800° C. in an argon atmosphere at a heating rate of 5° C. min⁻¹ for a soaking time of 8 hours, before the final NVP-C product was obtained. Based on the initial precursor mass, the final calcinated product yields were between 75% and 80% due to particles bonding to the wall of the main spray drier chamber.

### Material Characterization

X-ray diffraction (XRD) was performed with a Bruker D8 Advance powder diffraction system. A Thermofisher Quattro S ESEM microscope was used for scanning electron microscopy. Thermogravimetric analysis (TGA) was performed on a TA Instruments Q5000 Automatic Sample Processor under an air atmosphere to determine the final carbon content of the powder. Raman spectroscopy was performed using a Renishaw in Via Raman microscope with an excitation wavelength of 532 nm. Brunauer-Emmett-Teller (BET) surface area analysis was completed on a Quantachrome Nova 2000e after degassing the sample overnight at 300° C.

### Electrochemical Performance

The electrochemical performance of the obtained NVP-C microspheres was determined with Na-ion half-cells constructed using CR2025 coin cell cases. Low loading NVP-C cathodes were made using a traditional slurry composed of 80 wt. % NVP powder, 10 wt. % HSV900 PVDF binder (MTI), and 10 wt. % Ketjenblack EC-300J (Fuelcell Store) or EC-600J (MSE supplies), in sufficient N-methyl-2-pyrrolidone (NMP) solvent. The slurry was mixed in a vortex mixer and coated onto aluminum foil before being dried in a convection oven at 80° C. Electrodes were cut into 8 mm diameter circles and vacuum dried at 120° C. overnight. Active material loading was maintained between 0.5-1 mg cm⁻². High loading NVP-C cathodes (active material loading of 13.5 mg cm⁻²) were made with 80 wt. % NVP powder, 15 wt. % HSV900 PVDF binder (MTI), and 5 wt. % Ketjenblack EC-600J (MSE supplies). Na-ion half-cells were constructed with NVP-C as the cathode, a PP-PE-PP trilayer separator (Celgard), and a sodium metal counter electrode. The electrolyte was 1M NaPF₆ in diglyme. A LAND CT2001A battery testing system was used to evaluate the constant-current electrochemical cycling performance of the cells. Cyclic voltammetry was performed using a Gamry 600+potentiostat.

### Results

This procedure demonstrates a quick, sustainable one-pot method for synthesizing NVP-C using water as a solvent. It has recently been demonstrated that a spray drying synthesis method using methanol as a solvent and glucose as a carbon source. However, when water was substituted for methanol, the product was less porous and had vastly inferior performance. Similarly, graphene-scaffolded NVP-C particles have been successfully synthesized using graphene oxide dispersed in an aqueous precursor slurry. For scaled up synthesis, it is preferable to avoid expensive additives, such as graphene oxide, as well as hazardous solvents, such as methanol, that require an inert atmosphere. In this method, L-ascorbic acid both chemically reduces the vanadium pentoxide in the aqueous slurry, resulting in a turquoise spray-dried product (FIG. 1), and provides a simple inexpensive carbon source for the final calcified product.

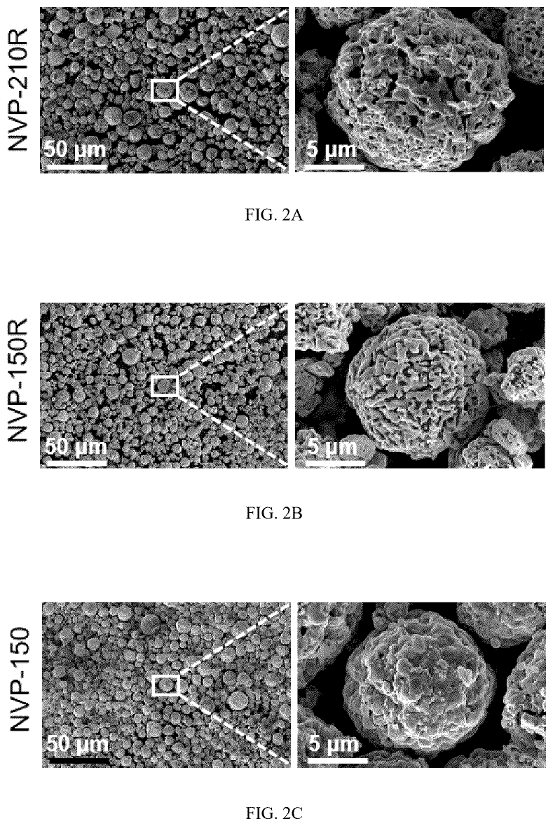

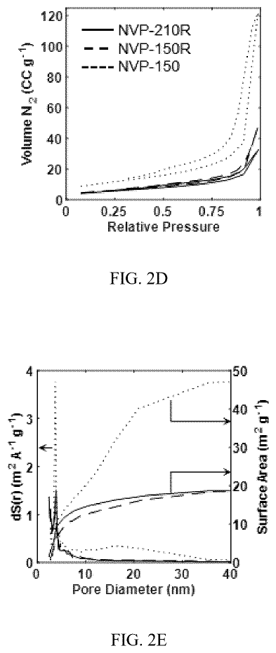

Three NVP-C products were synthesized. Two were spray dried at 150° C.: One, with a low carbon content (LC) was calcified after vacuuming and refilling the furnace chamber with argon 3 times (NVP-150R). The other was more extensively flushed with argon, resulting in a higher carbon content (NVP-150). The third product was spray dried at 210° C. and calcified with extensive argon purging and a high argon flow rate (NVP-210). The spray drying synthesis created small droplets of colloidal suspension that dried quickly, yielding spherical particles between 3 and 30 μm in diameter, as shown in FIGS. 2A-2C. Adding L-ascorbic acid to the precursor slurry did not impede the formation of highly porous hierarchical particles and gave high yields from an aqueous slurry.

FIG. 2D shows isotherms of the three NVP-C materials. BET analysis indicates specific surface areas of 21.09 m²g⁻¹, 39.55 m²g⁻¹, and 19.45 m²g⁻¹ for NVP-150R, 150° C._HC, and 210° C., respectively. Although the SEM image for NVP-150 appears denser than the other materials, pore size distributions (FIG. 2E) indicate that all pores fall below 50 nm and are therefore too small to be visible under SEM. Additionally, the spike in the differential surface area of NVP-150 at 3.7 nm is more prominent than the other samples.

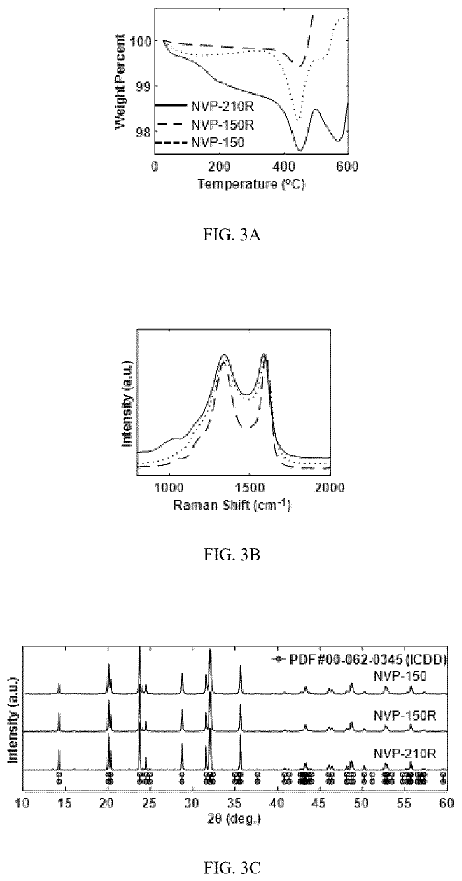

As shown in FIG. 3C, XRD patterns for all samples demonstrate sharp peaks that are well-indexed to the rhombohedral PDF card #00-062-0345 (ICDD), indicating highly crystalline NVP. FIG. 3A shows weight loss curves for TGA performed in a dry air atmosphere, which were used to estimate the amount of carbon in each sample. NVP-150R shows the lowest carbon content, 0.57 wt. %, attributed to combustion of carbon with residual oxygen present during calcination. Ensuring more rigorous argon protection during calcination for NVP-150 and 210° C. resulted in higher carbon contents of 1.75 wt. % and 2.41 wt. %, respectively. As shown in FIG. 3B, the Raman spectra of all samples exhibit two characteristic bands centered at ˜1345 cm⁻¹ and ˜1595 cm⁻¹, ascribed to the D-band (disordered) and G-band (graphitized) carbon. The intensity ratios of the peaks (I_{D}/I_{G}) are 0.93, 0.96, and 0.99 for NVP-150, 150° C._LC, and 210° C., respectively, indicating that approximately half of the residual carbon was graphitized.

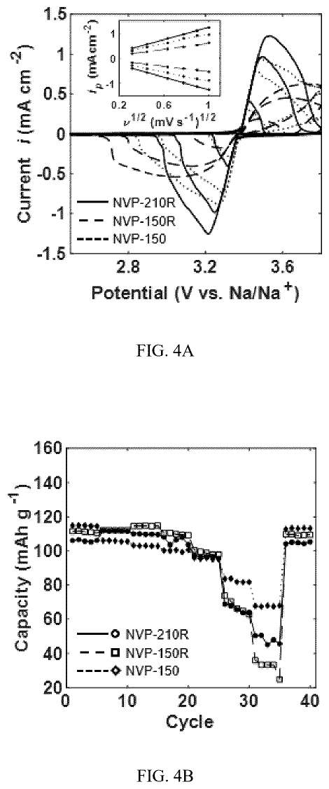

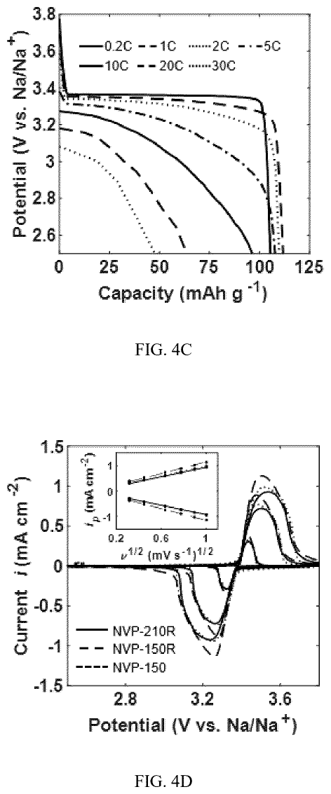

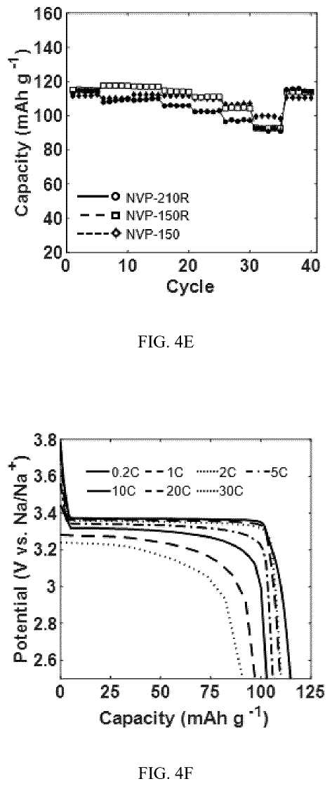

To investigate the effect of the NVP-C carbon content on electrochemical kinetics, cathodes were cast with 10 wt. % of either Ketjenblack EC-300J or EC-600J and tested in half-cells. The CV curves in FIG. 4A and FIG. 4D were used to perform Randles-Sevcik analysis and extract apparent diffusion coefficients, Dₐₚₚ, using the following equation³²:

$${i}_{p} = 2.69 \times {10}^{5} {n}^{3 / 2} {AC}_{{Na}^{+}} {{D}_{app}}^{1 / 2} {v}^{1 / 2} \qquad Eq . ( 1 )$$

Here, iₚ is the observed current response, n is the number of electrons transferred (two in this case), A is the electrode area, C_{Na}_{⁺} is the concentration of Nations in the NVP-C material (6.92×10⁻³ mol cm⁻³, based on two mobile Na⁺ions), Dₐₚₚ is the apparent diffusion coefficient of Na⁺ in NVP-C, and v is the scan rate. For this disclosure, Dₐₚₚ values (Table 1) were calculated using both the geometric area of the electrode (A_{geo}) as well as the surface area determined from BET testing. Intuitively, A_{BET} should be used in Eq. (1), as it more accurately represents the interfacial area between the active material and the electrolyte. However, studies on intercalation porous electrodes have demonstrated that not all particles or interfacial areas react concurrently. Instead, an in-plane particle-by-particle process and cross-plane layer-by-layer process are observed, making A_{geo} a more reasonable choice to yield diffusion coefficients closer to density functional theory (DFT). Furthermore, the obtained pore size distributions (FIG. 3B) indicate that a considerable portion of the calculated surface area is derived from pores smaller than 4 nm, particularly in the case of NVP-150, which may not be fully wet by large solvent molecules like diglyme. Therefore, diffusion coefficients based on ABET inevitably underestimate the true kinetics and must be used with caution as the lower limit. Likewise, those based on A_{geo} should be taken as upper limits. More accurate diffusion coefficients should be determined using an experimental setup where the actual active interfacial area can be determined.

When mixed with Ketjenblack EC-300J, Dₐₚₚ values (calculated using A_{geo}) increase with carbon content, as Dₐₚₚ^{150° C_LC}<Dₐₚₚ^{150° C._HC}<Dₐₚₚ^{210° C.}.The shape of the CV curves also improves with increasing carbon content, demonstrating narrower and more symmetric peaks. Conversely, cathodes mixed with Ketjenblack EC-600J show the reverse trend, with Dₐₚₚ values decreasing with increasing carbon content. CV curves with Ketjenblack EC-600J all demonstrate narrow peaks and high symmetry. These results suggest that the high porosity of the samples allows for intimate contact with the electrolyte and enables facile ionic transport, while the low carbon content of the NVP-C materials creates an electronic limitation. When mixed with the less conductive Ketjenblack EC-300J, this electronic limitation is exacerbated; thus, increasing the carbon content of the NVP-C secondary particles alleviates this limitation and results in higher Dₐₚₚ values. When mixed with the more conductive Ketjenblack EC-600J, this electronic limitation is removed and ionic transport through the carbon coating becomes the limiting kinetic factor, thus samples with higher carbon contents demonstrate lower Dₐₚₚ values.

TABLE 1
Apparent diffusion coefficients Dₐₚₚ in cm² s⁻¹ for the three NVP-C materials
mixed with Ketjenblack EC-300 J or EC-600 J. Values were calculated using both the geometric
area, A_{geo}, and the BET determined surface area, A_{BET}.

| | | 150° C._LC | | 150° C._HC | | 210° C. | |
|---|---|---|---|---|---|---|---|
| Ketjenblack | Area | Charge | Discharge | Charge | Discharge | Charge | Discharge |
| EC-300 J | A_{geo} | 1.30 × 10 [symbol] | 1.03 × 10 [symbol] | 3.52 × 10 [symbol] | 3.01 × 10 [symbol] | 5.58 × 10 [symbol] | 5.78 × 10 [symbol] |
| (cm² s⁻¹) | A_{BET} | 4.92 × 10 [symbol] | 3.91 × 10 [symbol] | 3.85 × 10 [symbol] | 3.29 × 10 [symbol] | 3.00 × 10 [symbol] | 3.11 × 10 [symbol] |
| EC-600 J | A_{geo} | 4.76 × 10 [symbol] | 4.78 × 10 [symbol] | 3.55 × 10 [symbol] | 3.23 × 10 [symbol] | 3.16 × 10 [symbol] | 3.10 × 10 [symbol] |
| (cm² s⁻¹) | A_{BET} | 2.71 × 10 [symbol] | 2.72 × 10 [symbol] | 6.74 × 10 [symbol] | 6.13 × 10 [symbol] | 3.11 × 10 [symbol] | 3.06 × 10 [symbol] |

[symbol]

indicates data missing or illegible when filed

Discharge capacities during constant current ramp tests shown in FIG. 4B and FIG. 4E corroborate this claim. All materials initially demonstrate a specific capacity close to the theoretical value of 117 mAh g⁻¹ at 0.2 C, and all cells return to this initial value after cycling at high C-rates, indicating a robust material. The increase in specific capacity during early cycling is attributed to electrolyte wetting the cathode. When mixed with Ketjenblack EC-300J, NVP-150R demonstrates lower specific capacity at high C-rates than NVP-210. However, when mixed with Ketjenblack EC-600J, the materials perform similarly, with NVP-150R showing slightly better rate performance up to 20 C. As a result of its high surface area, NVP-150 shows the highest capacity at rates greater than 20 C regardless of the conductive additive. There is clearly a tradeoff between ionic and electronic transport limitations in the NVP-C material; however, the discharge profiles of NVP-210 in FIG. 4C and FIG. 4F indicate that the material is still electronically limited at high C-rates. When mixed with Ketjenblack EC-300J, discharge plateaus (vs. Na/Na⁺) decrease from 3.37 V at 0.2 C to 3.00 V at 30 C. When mixed with Ketjenblack EC-600J, the higher electronic conductivity leads to a lower overpotential and a discharge plateau at 3.23 V vs. Na/Na⁺ at 30 C.

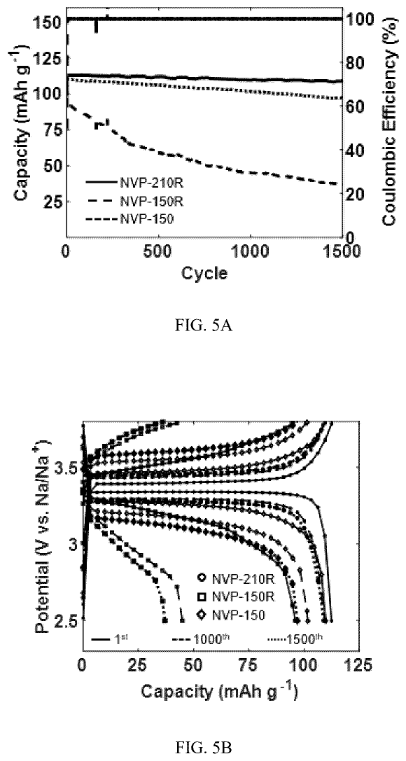

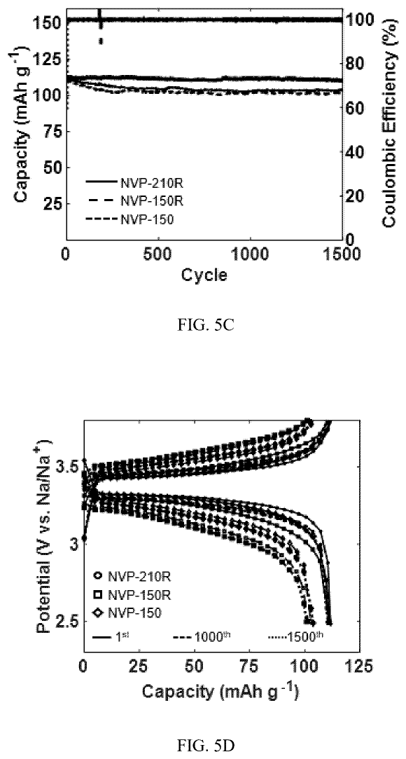

FIGS. 5A-5D demonstrates the longevity of the NVP-C materials cycled at 10 C between 2.5 V and 3.8 V vs. Na/Na+. When cathodes are mixed with Ketjenblack EC-300J (FIG. 5A and FIG. 5B), NVP-210 clearly outperforms the two lower carbon counterparts, retaining 94.9% of its initial capacity after 2000 cycles while maintaining a coulombic efficiency near 100%. NVP-150 retains 85.3% of its initial capacity, while NVP-150R degrades quickly, with a final retention of 29.6%. Galvanostatic potential profiles during cycles 1, 1000, and 2000 also reflect this performance trend. During cycling, the overpotential for NVP-210 increases from 30 to 95 mV. On the other hand, the overpotential for NVP-150 increases from 95 to 245 mV, while NVP-150R shows the most dramatic increase, from 115 to 395 mV.

Changing the electronic conductivity additive to Ketjenblack EC-600J improves the performance of all three samples (FIG. 5C and FIG. 5D). NVP-150R demonstrates the most dramatic improvement, retaining 89.3% of its initial capacity, while overpotential increases from 75 to 155 mV. NVP-150 also shows significant improvement, with a final retention of 92.8% and an overpotential increase from 55 to 140 mV. Around cycle 1600, the cell's coulombic efficiency drops to a minimum of 80%, attributed to electrolyte decomposition; however, the cell regains its high efficiency by the 2000^{th} cycle. Finally, NVP-210 demonstrates an impressive retention of 97.8%, with minimal overpotential increase from 55 to 80 mV.

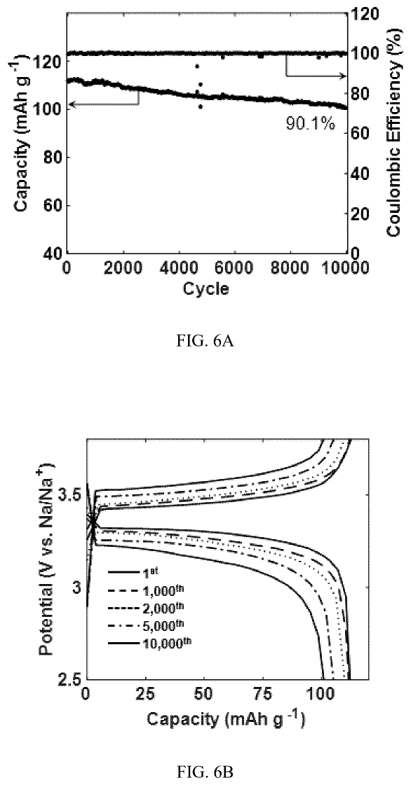

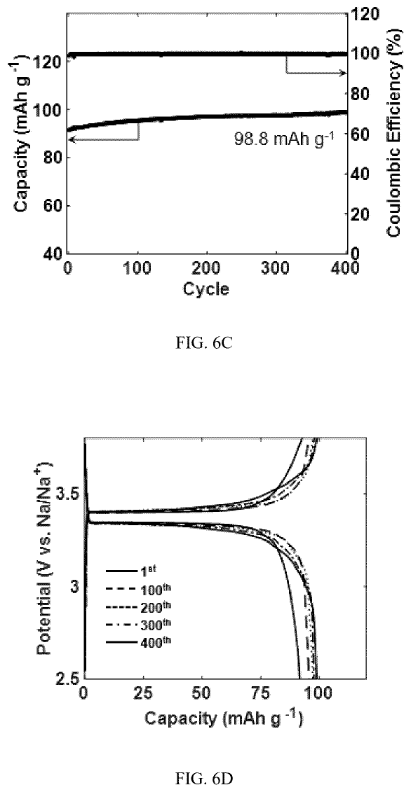

As shown in FIG. 6A and FIG. 6B, after 5000 cycles at 10 C the low-capacity NVP-210° C. cathodes mixed with Ketjenblack EC-600J retained 93.8% of the initial specific capacity with final overpotential of 127.5 mV. To demonstrate the efficacy of the NVP-C material with a more realistic active material loading, high-capacity half-cells were constructed using NVP-210. FIG. 6C and FIG. 6D show cycling data from a cell with an area capacity of 1.35 mAh cm⁻² (an active material loading of 13.50 mg cm⁻²) cycled at 0.5 C. The cell had an initial discharge capacity of 91.5 mAh g⁻¹, which increased to 98.8 mAh g⁻¹ after 400 cycles while maintaining high coulombic efficiency. The low initial value and increase in specific capacity are attributed to wetting of the cathode as cycling progresses. To further implement this material, high-capacity slurry casting must be optimized to allow for full use of the active material. However, the galvanostatic potential profiles of the high-capacity half-cell demonstrate an initial overpotential of 27.1 mV that increases to 31.6 mV. Such a small overpotential and the stable cycling curves suggest that the NVP-210 material is not only suitable for small scale testing in coin cells but can also be used in realistic battery storage applications.

This example demonstrates a one-pot, three-step method to synthesize microparticles of sodium vanadium phosphate. The three steps are ball milling, spray drying, and calcination. The final product exhibits superior performance relative to all known comparative processes. The electrodes made with the synthesized particles show only 6.2% capacity degradation after 5,000 cycles of fast charging-discharging at 10 C-rate (i.e. 6-min charging and 6-min discharging).

### Example 2. Parameter Optimization

It was discovered that two potential procedure alterations may have a material effect on the resulting product. First, spray-drying the precursor immediately after ball milling. Second, resting the ball-milled precursor (e.g., overnight) before spray drying.

It was also discovered that the carbon source may have a material effect on the resulting product. Glucose was an unsuitable carbon source; it was too sticky and resulted in less than 10% yield. Citric acid was also an unsuitable carbon source; it formed the wrong crystal phases, and no NVP was produced.

Samples were prepared generally according to the procedure described in Example 1. In this example, the sample naming is as follows:

| | | L-Ascorbic |
|---|---|---|
| | Sucrose | Acid |
| Spray-dried Immediately | NVP-S | NVP-L |
| Rested Overnight | NVP-Sr | NVP-Lr |

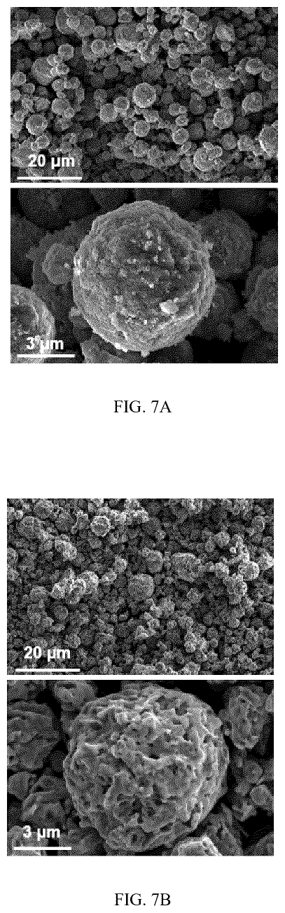

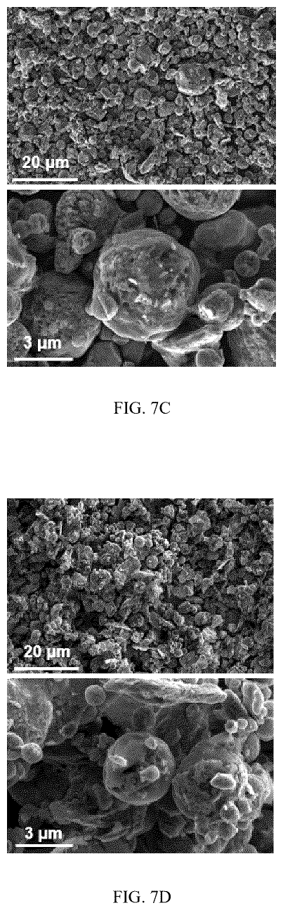

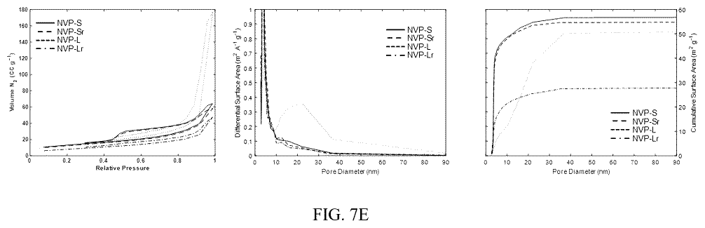

FIGS. 7A-7E depict the material SEM and BET of the samples. Using sucrose, with or without resting, yields irregular spherical particles with similarly high specific surface areas (55-57 m²g⁻¹) derived from pores almost exclusively ˜2.3 nm in radius. Using L-Ascorbic Acid without resting yields regular spherical particles with a similarly high specific surface area, but with a wider pore size distribution, with large contribution coming between 50-200 nm radius. Allowing the L-Ascorbic Acid sample to rest yields irregular spherical particles with a much lower specific surface area.

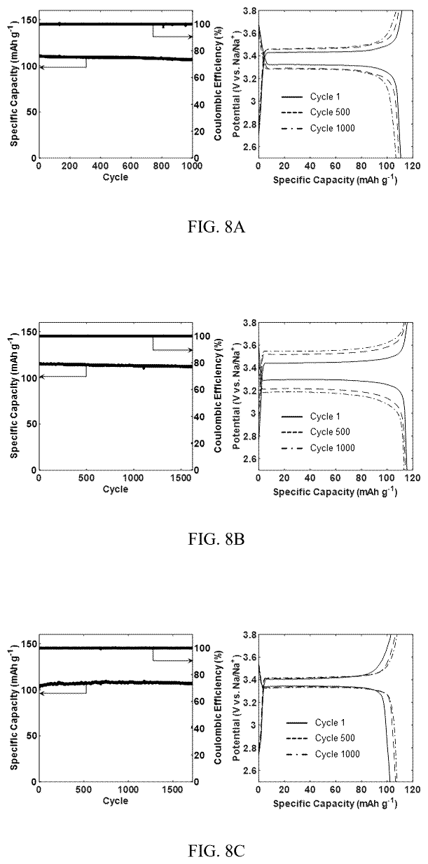

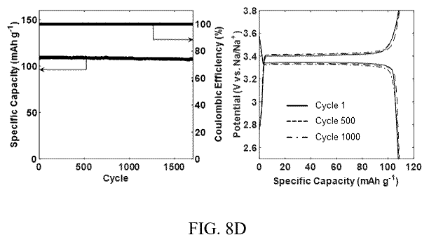

FIGS. 8A-8D depict the product cycling. All samples show good cycling performance at 3 C over the first 1000 cycles, with little degradation. NVP-S and NVP-Sr show a slight increase in specific capacity near the start of cycling, attributed to wetting of pores, and show little to no increase in overpotential as cycling continues. NVP-L shows slight increase in overpotential over the first 250 cycles, and little following. NVP-Lr shows continuous increase in overpotential, attributed to poor carbon coverage and thus continuous SEI formation on exposed NVP.

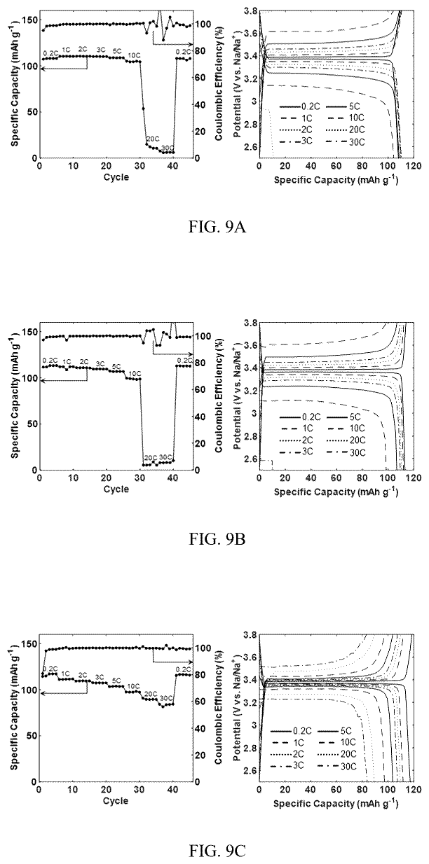

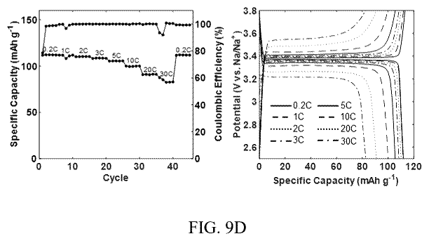

FIGS. 9A-9D depict the rate capability. NVP-S and NVP-Sr show continuous decrease in specific capacity as C-rate increases, maintaining ˜73% capacity retention at 30 C. NVP-L and NVP-Lr maintain their high specific capacity up to 10 C, then drop off suddenly at rates higher than 20 C.

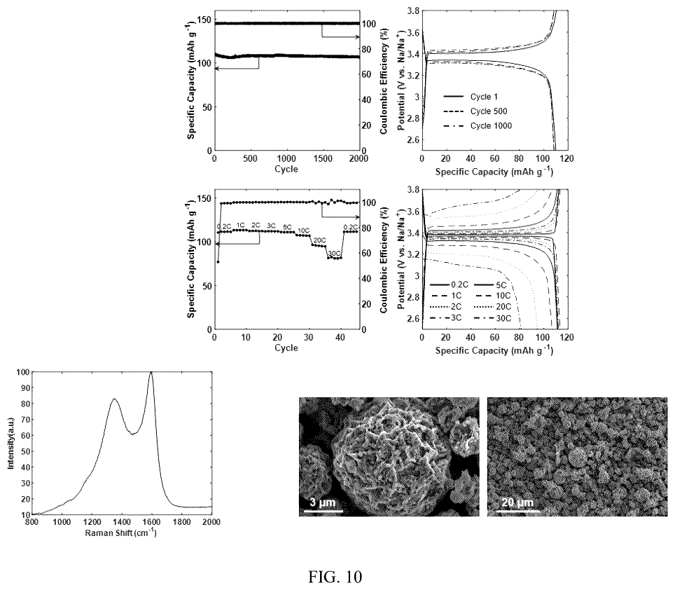

FIG. 10 depicts properties and characterizations for a mixed carbon source. Combining L-ascorbic acid and sucrose as the carbon sources yields a product that appears to have the best of both worlds—it shows good carbon coverage, little increase in overpotential with cycling, and maintains good specific capacity up to 10 C while still having satisfactory values at higher C-rates.

### Conclusions

Intermittent renewable energy sources can mitigate climate change, but they require high-performance, reliable batteries. The widely used lithium-ion batteries require Li, Co, and Ni, and the growing demand for these elements, together with their relatively few sources, has made them increasingly expensive. A promising alternative, sodium-ion batteries are economical because sodium and their associated cathode materials are abundant. As a high-potential cathode material for sodium-ion batteries, Na₃V₂(PO₄)₃ (NVP) offers high ionic conductivity due to its sodium super ionic conductor (NASICON) structure. However, the material suffers from poor electronic conductivity, and its synthesis methods, e.g., hydrothermal methods, are energy intensive. Recently, spray drying has been recognized as a more energy-effective synthesis route, but it still requires organic solvents or expensive nanocarbon additives.

In this disclosure, an efficient and sustainable method for synthesizing porous NVP-C hierarchical particles with tunable carbon contents was developed. The addition of L-ascorbic acid to an aqueous precursor slurry allowed for impressive yields, even at low spray drying temperatures, of a high-performance material that exhibits near-theoretical capacity, high rate capability, and longevity. Low carbon content samples were shown to be limited by electronic conductivity, which may be alleviated by the addition of better conductive additives. In particular, a more efficient and sustainable aqueous spray-drying method is presented to synthesize carbon-coated NVP (NVP-C) by using L-ascorbic acid as a carbon source. NVP-C sodium-ion half cells showed very high reversible capacity (114.7 mAh g⁻¹ at 0.2 C), high rate capability (80.8% capacity retention at 30 C), and long cycling performance (93.8% capacity retention after 5000 cycles at 10 C). In the future, the synthesis may be improved to further reduce its energy consumption and yield a more precise carbon content. This disclosure has highlighted NVP-C as a viable inexpensive alternative to lithium-based batteries, particularly for large-scale stationary energy storage systems.

### Definitions

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the disclosure, but their usage does not delimit the disclosure, except as outlined in the claims.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that vary depending upon the desired properties sought to be obtained by a particular embodiment. In some embodiments, the numerical parameters are be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) are construed to cover both the singular and the plural, unless specifically noted otherwise. In some embodiments, the term “or” as used herein, including the claims, is used to mean “and/or” unless explicitly indicated to refer to alternatives only or to refer to the alternatives that are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and may also cover other unlisted steps. Similarly, any composition or device that “comprises,” “has” or “includes” one or more features is not limited to possessing only those one or more features and may cover other unlisted features.

All methods described herein are performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member is referred to and claimed individually or in any combination with other members of the group or other elements found herein. One or more members of a group are included in, or deleted from, a group for reasons of convenience or patentability. When any such inclusion or deletion occurs, the specification is herein deemed to contain the group as modified thus fulfilling the written description of all Markush groups used in the appended claims.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method to synthesize carbon-coated sodium vanadium phosphate (NVP-C) microspheres, the method comprising:
ball milling a mixture of a sodium phosphate source, a vanadium source, a carbon source, and a solvent to form a precursor;
spray drying the precursor; and
calcinating the precursor.

2. The method of claim 1, wherein the sodium phosphate source is selected from the group consisting of sodium dihydrogen phosphate, disodium hydrogen phosphate, trisodium phosphate, monoammonium phosphate, and combinations thereof.

3. The method of claim 1, wherein the vanadium source is selected from the group consisting of vanadium oxides, V₂O₅, V₂O₃, V₂O₄, VO₂, NH₄VO₃, and combinations thereof.

4. The method of claim 1, wherein the carbon source functions as a reducing agent for the vanadium source.

5. The method of claim 1, wherein the carbon source is selected from the group consisting of citric acid, glucose, L-ascorbic acid, maltodextrin, oxalic acid, trehalose, sucrose, and combinations thereof.

6. The method of claim 1, wherein the solvent is selected from the group consisting of water, methanol, and combinations thereof.

7. The method of claim 1, wherein the method is a one-pot method.

8. The method of claim 1, wherein the spray drying the precursor occurs immediately after the ball milling.

9. The method of claim 1, further comprising resting the precursor after the ball milling.

10. The method of claim 9, wherein the resting occurs for a time of at least about four hours.

11. The method of claim 9, wherein the spray drying the precursor occurs after the resting the precursor.

12. The method of claim 1, wherein the calcining the precursor comprises applying a temperature in a range of from about 600° C. to about 1000° C. for a time in a range of from about 1 hour to about 16 hours.

13. Carbon-coated sodium vanadium phosphate (NVP-C) microspheres comprising at least one of the following properties:
a surface area in a range of from about 20 m² g⁻¹ to about 100 m² g⁻¹;
a morphology selected from the group consisting of hierarchical spherical secondary particles composed of nano-sized primary particles, hierarchical plate-like secondary particles composed of nano-sized primary particles, and combinations thereof;
a pore size distribution selected from the group consisting of a pore size distribution closely centered around 5 nm in diameter, widely distributed between 5 nm to 40 nm in diameter, and combinations thereof; and
a carbon coating thickness in a range of from about 5 nm to about 30 nm.

14. The NVP-C microspheres according to claim 13, comprising a surface area in a range of from about 20 m² g⁻¹ to about 100 m² g⁻¹.

15. The NVP-C microspheres according to claim 13, comprising a morphology selected from the group consisting of hierarchical spherical secondary particles composed of nano-sized primary particles, hierarchical plate-like secondary particles composed of nano-sized primary particles, and combinations thereof.

16. The NVP-C microspheres according to claim 13, comprising a pore size distribution selected from the group consisting of a pore size distribution closely centered around 5 nm in diameter, widely distributed between 5 nm to 40 nm in diameter, and combinations thereof.

17. The NVP-C microspheres according to claim 13, comprising a carbon coating thickness in a range of from about 5 nm to about 30 nm.

18. A cathode comprising the NVP-C microspheres according to claim 13.

19. A battery comprising the cathode according to claim 18.

20. The battery according to claim 19, wherein the battery is a sodium-based battery.
